(19) United States
(12) Patent Application Publication
(10) Pub. No.: US 2012/0056558 A1
(43) Pub. Date: Mar. 8, 2012

(54) DISPLAY DEVICE AND ELECTRONIC DEVICE USING THE SAME

(75) Inventors: Inada Toshiya, Miao-Li County (TW); Hajime Nagai, Miao-Li County (TW)

(73) Assignee: CHIMEI INNOLUX CORPORATION, Miao-Li County (TW)

(21) Appl. No.: 13/216,622

(22) Filed: Aug. 24, 2011

(30) Foreign Application Priority Data
Sep. 2, 2010 (JP) 2010-196467

(51) Int. Cl. H05B 37/02

(52) U.S. Cl. 315/294

(57) ABSTRACT

The invention provides a low-power consumption display device. The display device 10 is provided with a plurality of pixels P₁₁˜Pₙₘ arranged in a matrix formed by columns and rows, and a plurality of signal lines 16-1˜16-m arranged corresponding to every pixel rows or pixel columns. The display device further comprises a signal voltage generating part 12 electrically connected to the plurality of pixels P₁₁˜Pₙₘ via the plurality of signal lines 16-1˜16-m and generating signal voltages which are applied to the plurality of signal lines 16-1˜16-m, and a signal voltage amplifying part 14 amplifying the signal voltage generated by the signal voltage generating part 12 to a necessary drive voltage for each of the plurality of pixels P₁₁˜Pₙₘ.

### CROSS REFERENCE TO RELATED APPLICATIONS

This Application claims priority of Japanese Patent Application No. 2010-196467, filed on Sep. 2, 2010, the entirety of which is incorporated by reference herein.

### BACKGROUND OF THE INVENTION

1. Field of the Invention

The present invention relates to a display device having a plurality of pixels arranged in a matrix formed by rows and columns and a plurality of signal lines corresponding to the rows or the columns, and an electronic device using the same

2. Description of the Related Art

For a display device having a plurality of pixels arranged in a matrix formed by rows and columns, each pixel comprises a switch element provided at a cross region of a signal line (or called a source line) and a scan line (or called a gate line). Each pixel further comprises a pixel electrode formed on a substrate where the switch element is formed and a common electrode formed on an opposite substrate. The common electrode connects all pixels to a predetermined voltage source. The switch element is conducted in response to a scan signal transmitted by the gate line arranged corresponding to the row the pixel belongs to. In general, a period wherein the switch element is conducted is called a scan period. During the scan period, the pixel electrode is connected to the source line arranged corresponding to the column the pixel belongs to through the switch element, and thus is applied with a signal voltage. As a result, a voltage difference is generated between the pixel electrode and the common electrode such that the pixel is driven.

The display device is provided with a signal voltage generating device for generating a signal voltage. The signal voltage generating device is usually called a source driver and is incorporated into a driver integrated circuit (IC) which is independent from the display panel having a plurality of pixels arranged in a matrix.

The source driver is coupled to every pixel through the source lines. Thus, the power for a driver IC to provide a signal voltage to each pixel is proportional to the product of the capacity of the source line and the amplitude of the signal voltage. In this regard, a low signal voltage is preferred. To lower the signal voltage, methods such as lowering the pixel driving voltage or lowering the output voltage of the driver IC have been proposed (for example, refer to Patent documents 1 and 2).

Patent document 1: Japanese Patent Application Publication no. 2009-181066

Patent document 2: Japanese Patent Application Publication no. 2007-225843

However, the pixel driving voltage is determined by the characteristic of the materials used to make the display elements. Because of temperature, brightness, or other condition limitations, the pixel driving voltage cannot be easily lowered. In recent years, progress has been made to lower power consumption for driver ICs, such that the output voltage of the driver IC is also lowered. Even so, lowering the pixel driving voltage is still limited, such that a driver IC having a low output voltage cannot be effectively utilized in a display device.

According to the above issue, the purpose of the invention is to provide a display device with lower power consumption and an electronic device using the same.

### BRIEF SUMMARY OF THE INVENTION

A detailed description is given in the following embodiments with reference to the accompanying drawings.

The invention provides a display device, including: a plurality of pixels arranged in a matrix formed by rows and columns; a plurality of signal lines arranged corresponding to each pixel row or each pixel column, respectively; a signal voltage generating part connected to the plurality of pixels via the plurality of signal lines, for generating a signal voltage to be applied to each of the plurality of signal lines; and a signal voltage amplifying part for amplifying the signal voltage generated by the signal voltage generating part to a necessary drive voltage for each of the plurality of pixels.

Therefore, a display device with low power consumption may be realized.

In one embodiment, the display device further includes: a display panel divided into the plurality of pixels, wherein the display panel has a substrate where a circuit is formed, and the circuit is disposed corresponding to each of the plurality of pixels to control the driving of the pixel, wherein the signal voltage generating part is included in a driver integrated circuit disposed outside of the display panel, and the signal voltage amplifying part is formed together with the circuit on the substrate.

In a display device in accordance with an embodiment, the signal voltage amplifying part is formed in each of the plurality of pixels. In a display device in accordance with another embodiment, the signal voltage amplifying part is disposed on each of the plurality of signal lines.

In a display device in accordance with an embodiment, in the case where each of the plurality of pixels having the signal voltage amplifying part is divided into a plurality of sub pixels, the signal voltage amplifying part includes a voltage distribution part disposed at an output terminal of the signal voltage amplifying part, wherein the voltage distribution part distributes the signal voltage amplified by the signal voltage amplifying part to the plurality of sub pixels. The voltage distribution part can include a demultiplexer.

In a display device in accordance with an embodiment, the signal voltage amplifying part is an amplifying circuit having an operational amplifier, or a charge pump circuit.

In one embodiment, the display device further includes: a capacity storage capacitor formed in each of the plurality of pixels, for holding the drive voltage applied to the pixel; a plurality of capacity storage lines arranged corresponding to each of the pixel rows or each of the pixel columns and connected to the capacity storage capacitor; and a capacity storage line driver for driving the plurality of capacity storage lines in synchronization with the driving of each of the plurality of pixels.

In one embodiment, the display device is an LCD device, an OLED device, or electronic paper.

In one embodiment, the display device is utilized in an electronic device capable of providing user images, for example, a television, a laptop or desktop personal computer, a cell phone, a PDA, a car navigation device, a portable game device, an AURORA VISION or etc.

According to the invention, a display device with low power consumption or an electronic device thereof is provided.

### BRIEF DESCRIPTION OF THE DRAWINGS

The present invention can be more fully understood by reading the subsequent detailed description and examples with references made to the accompanying drawings, wherein:

FIG. 1 is a block diagram of a display device in accordance with Embodiment 1 of the invention.

FIG. 2 is a circuitry diagram of a pixel in the display device in accordance with Embodiment 1 of the invention.

FIG. 3 is a timing chart for describing the operation of the amplifier circuit shown in FIG. 2.

FIG. 4 is another circuitry diagram of a pixel in the display device in accordance with Embodiment 1 of the invention.

FIG. 5 is a modification of the circuitry shown in FIG. 4.

FIG. 6 is another circuitry diagram of a pixel in the display device in accordance with Embodiment 1 of the invention.

FIG. 7 is a timing chart for describing the operation of the amplifier circuit shown in FIG. 6.

FIG. 8 is a block diagram of a display device in accordance with Embodiment 2 of the invention.

FIG. 9 is a circuitry diagram of an amplifier circuit arranged on each source line in the display device in accordance with Embodiment 2.

FIG. 10 is a timing chart for describing the operation of the amplifier circuit shown in FIG. 9.

FIG. 11 is a block diagram of a display device in accordance with Embodiment 3 of the invention.

FIGS. 12(a), 12(b), and 12(c) show the effect of the capacitive coupling driving adopted in a structure of the invention.

FIG. 13 is an example showing an electronic device in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

### Embodiment 1

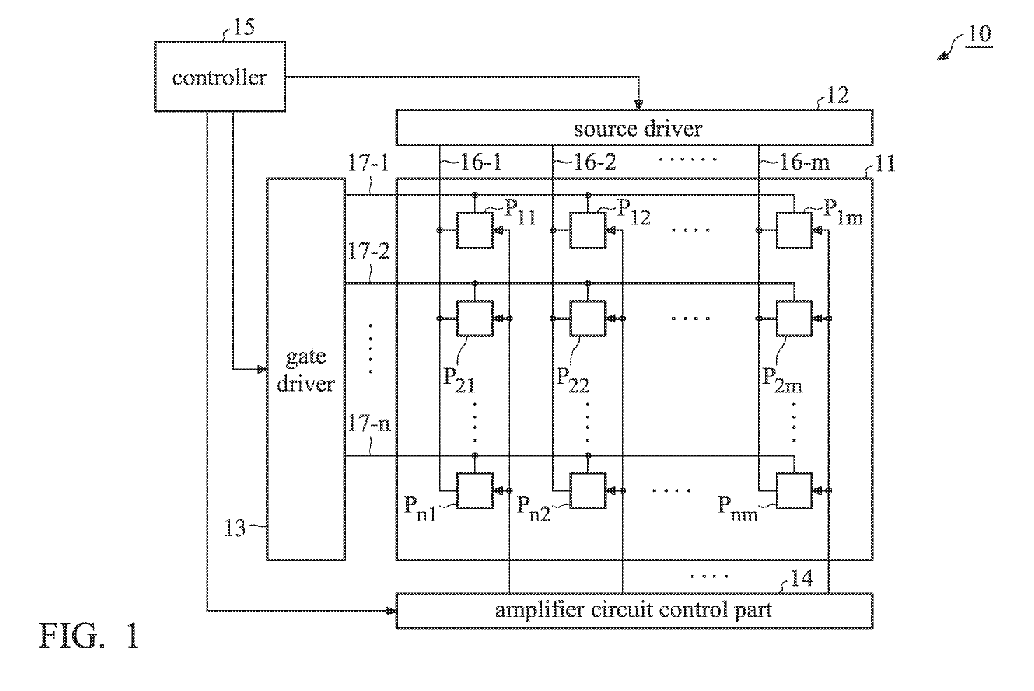

FIG. 1 is a block diagram of a display device in accordance with Embodiment 1 of the invention. In FIG. 1, a display device 10 comprises a display panel 11, a source driver 12, a gate driver 13, an amplifier circuit control part 14, and a controller 15.

The display panel 11 comprises a plurality of pixels P₁₁˜Pₙₘ (m and n are integers) arranged in a matrix formed by rows and columns. The display panel 11 further comprises a plurality of source lines 16-1˜16-m arranged corresponding to the columns, and a plurality of gate lines 17-1˜17-n arranged corresponding to the rows and orthogonal to the source lines 16-1˜16-m.

The source driver 12 generates signal voltages to the source lines 16-1˜16-m. The gate driver 13, via the gate lines 17-1˜17-n, controls signal voltage applications from the source lines 16-1˜16-m to the pixels P₁₁˜Pₙₘ. Specifically, the gate driver 13 drives pixel rows or columns (in FIG. 1, pixel rows are taken as an example) with an interlaced scan or progressive scan procedure so that the pixels on that pixel row are applied with signal voltages through the source lines. For example, in the liquid crystal display device, by applying the signal voltages to the pixels, the orientation of the liquid crystal molecules is varied so as to polarize back light or external light (reflected light) to display images.

The amplifier circuit control part 14 synchronizes with the driving timings of each pixel. Namely, the amplifier circuit control part 14 synchronizes with a scan signal application from the gate driver 13 to the gate lines 17-1˜17-n and controls a signal voltage amplifier disposed in each pixel to amplify a signal voltage for each pixel.

The controller 15 synchronizes the source driver 12, the gate driver 13, and the amplifier circuit control part 14 together, and controls the above devices.

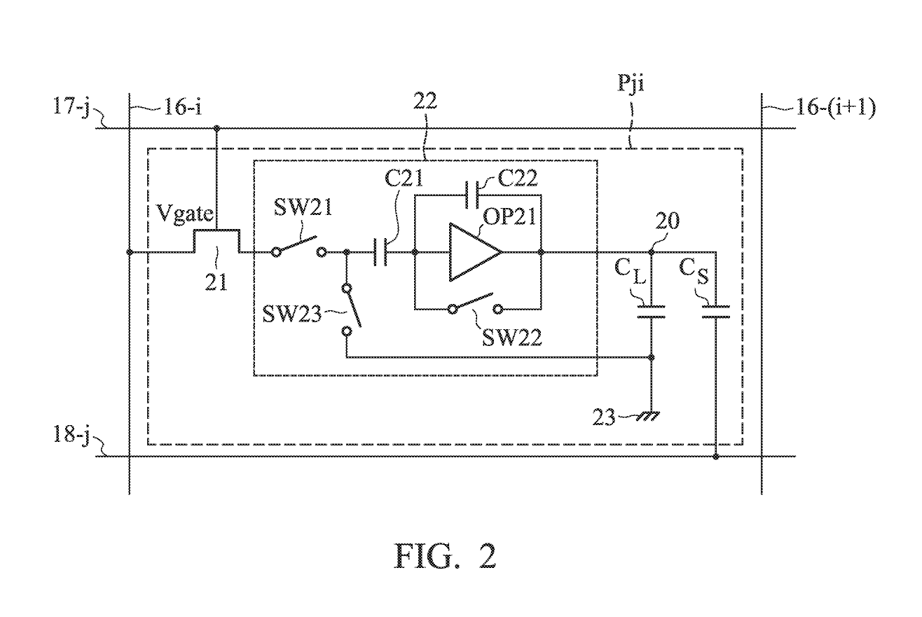

FIG. 2 is a circuitry diagram of a pixel in the display device in accordance with Embodiment 1 of the invention. The display device can be any kind of display device such as an LCD device, an OLED device, or electronic paper. Here, an LCD display is taken as an example.

The pixel Pⱼᵢ (i and j are integers, wherein 1≦i≦m and 1≦j≦n) are arranged at the cross region of the i-th source line 16-i and the j-th gate line 17-j.

The pixel Pⱼᵢ comprises a pixel electrode 20, a switch element 21 formed on a substrate where the pixel electrode 20 is formed, an amplifier circuit 22, and a common electrode 23 formed on an opposite substrate which faces the pixel electrode 20 across a liquid crystal layer. Briefly, a liquid crystal display element comprising the pixel electrode 20 and the common electrode 23 is represented by a capacitor C_{L} in FIG. 2. The common electrode 23 connects all pixels P₁₁˜Pₙₘ to a common and fixed voltage source (for example, grounding).

The control terminal of the switch element 21 is connected to the gate line 17-j. The switch element 21 responds to a scan signal transmitted by the gate line 17-j and then is conducted. During the scan period in which the switch element 21 is conducted, the pixel electrode 20 is electrically connected to the source line 16-i via the amplifier circuit 22 and the switch element 21.

The amplifier circuit 22 amplifies a signal voltage applied from the source line 16-i through the switch element 21 to the pixel electrode 20 to a necessary driving voltage for the display element C_{L}. The amplifier circuit 22 is a negative feedback amplifier circuit using switches and capacitors. The amplifier circuit 22 comprises an operational amplifier OP21, capacitors C21 and C22, and switches SW21, SW22 and SW23. The first capacitor C21 is connected to the input terminal of the operational amplifier OP21. The second capacitor C22 is connected between the input terminal and the output terminal of the operational amplifier OP21. The first switch SW21 is connected between the switch element SW21 and the first capacitor C21. The second switch SW22, connected in parallel with the second capacitor C22, is connected between the input terminal and the output terminal of the operational amplifier OP21. The third switch SW23 is connected between the common electrode 23 and a node located between the first switch SW21 and the first capacitor C21. The switches SW21˜SW23 are switched ON/OFF in response to control signals applied by the amplifier circuit control part 14, respectively.

In this manner, an amplified signal voltage is applied to the pixel electrode 20, and the liquid crystal display element C_{L} is driven by a voltage difference generated between the pixel electrode 20 and the common electrode 23

The pixel Pⱼᵢ further comprises a storage capacitor C_{S} holding the amplified signal voltage in the form of electrical charges during a period from the end of a scan period through the beginning of the next scan period. The period means a frame in which pixel data is being rewritten. One terminal of the storage capacitor C_{S} is connected to the pixel electrode 20 and the other terminal is connected to a capacity storage line 18-j. The voltage level of the capacity storage line 18-j is maintained at a predetermined and fixed voltage level. The storage capacitor C_{S} can also be connected to the common electrode 23 rather than the capacity storage line 18-j.

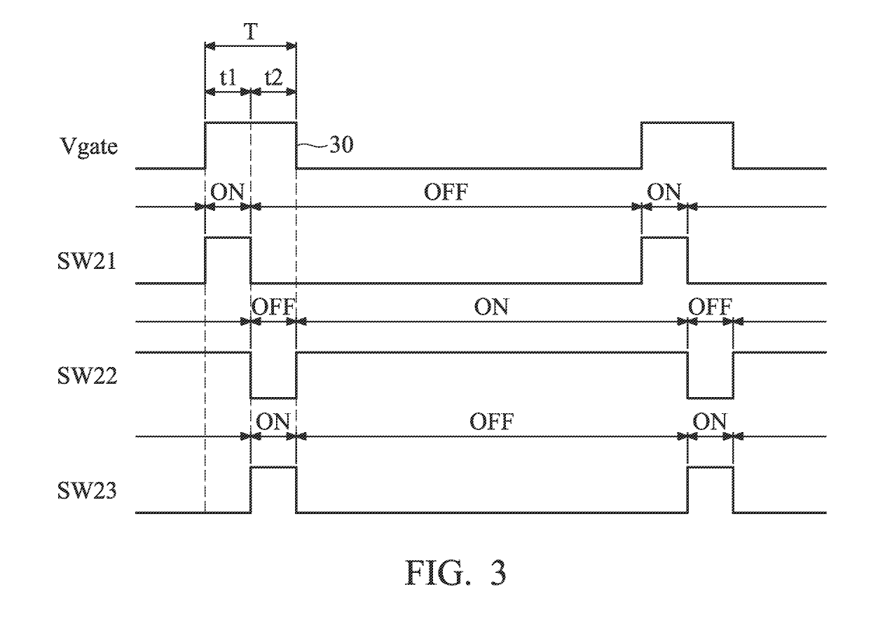

FIG. 3 is a timing chart for describing the operation of the amplifier circuit 22 shown in FIG. 2.

Regarding the example shown in FIG. 3, the gate driver 13 applies a scan signal 30 to the gate line 17-j to drive the pixels Pⱼᵢ˜Pⱼₘ in the j-th row. During the scan period T in which the scan signal 30 is being applied, the switch element 21 is ON.

Before the scan period T, the first switch SW21 and the third switch SW23 is OFF and the second switch SW22 is ON.

During a time duration t1, starting at the beginning of the scan period T, the amplifier circuit control part 14 turns on the first switch SW21. Meanwhile, the second switch SW22 is still ON and the third switch SW23 is still OFF. The input terminal of the negative feedback amplifier circuit is coupled to the source line 16-i, and thereby a signal voltage applied by the source driver 12 to the source line 16-i is charged into the first capacitor C21.

During a time duration t2, starting at the end of time duration t1 and ending at the end of the scan period T, the amplifier circuit control part 14 turns off the first switch SW21 and the second switch SW22, and turns on the third switch SW23. The negative feedback amplifier circuit is separated from the source line 16-i and provides an amplified signal voltage to the pixel electrode 20 to drive the liquid crystal display element C_{L}.

After the scan period T, the amplifier circuit control part 14 turns on the second switch SW22 and turns off the third switch SW23. Meanwhile, the first switch SW21 is still OFF. Thereby, the capacity storage capacitor C_{S} holds the amplified signal voltage in the form of electrical charges till the next scan for the pixel Pⱼᵢ.

As shown in FIGS. 2 and 3, by embedding an amplifier circuit into a pixel to amplify the signal voltage applied to the pixel, the voltage level of the signal voltage applied from the source driver 12 through the source lines 16-1˜16-m to each pixel is lowered. Thus, the display device in accordance with Embodiment 1 can reduce power consumption thereof.

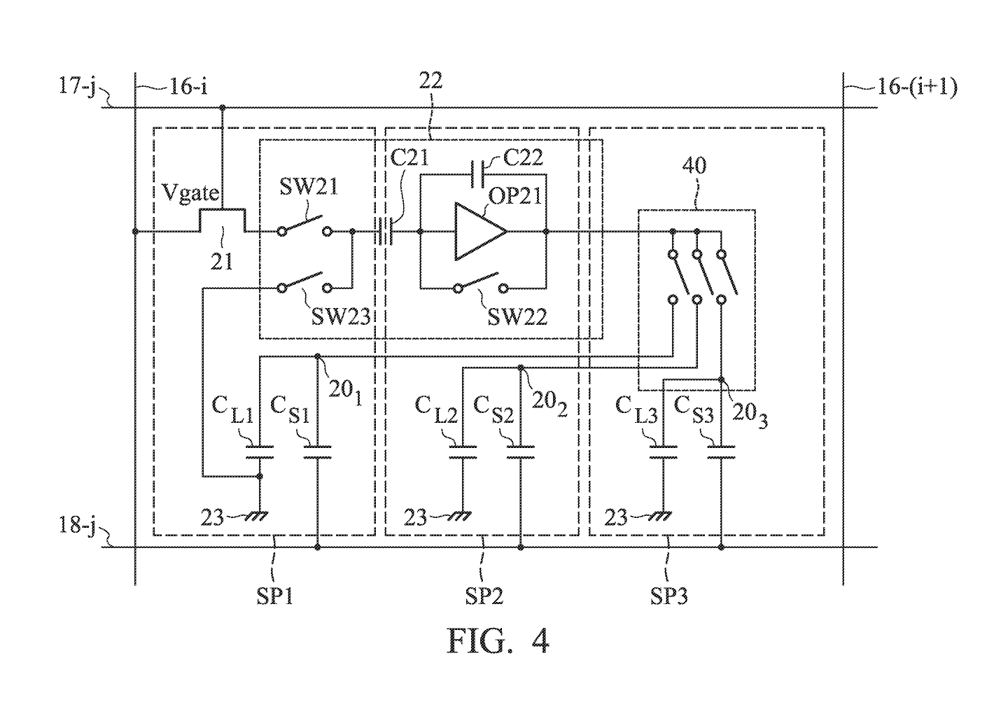

FIG. 4 is another circuitry diagram of a pixel in the display device in accordance with Embodiment 1 of the invention. The pixel shown in FIG. 4 is divided into three sub pixels SP1, SP2, and SP3, which is different from the pixel Pⱼᵢ shown in FIG. 2. The sub pixels SP1, SP2, and SP3 comprise pixel electrodes 20₁, 20₂, and 20₃, respectively. Display capacitors C_{L1}, C_{L2}, and C_{L3} are formed between each pixel electrode and the common electrode 23, respectively. The sub pixels SP1, SP2, and SP3 further comprise storage capacitors CS1, CS2, and CS3 connected between each pixel electrode and the capacity storage line 18-j, respectively. The switch element 21 and the amplifier circuit 22 are shared by all sub pixels SP1, SP2, and SP3. In order not to obstruct the aperture of each sub pixel, the amplifier circuit 22 is extended to be across all sub pixels SP1, SP2, and SP3.

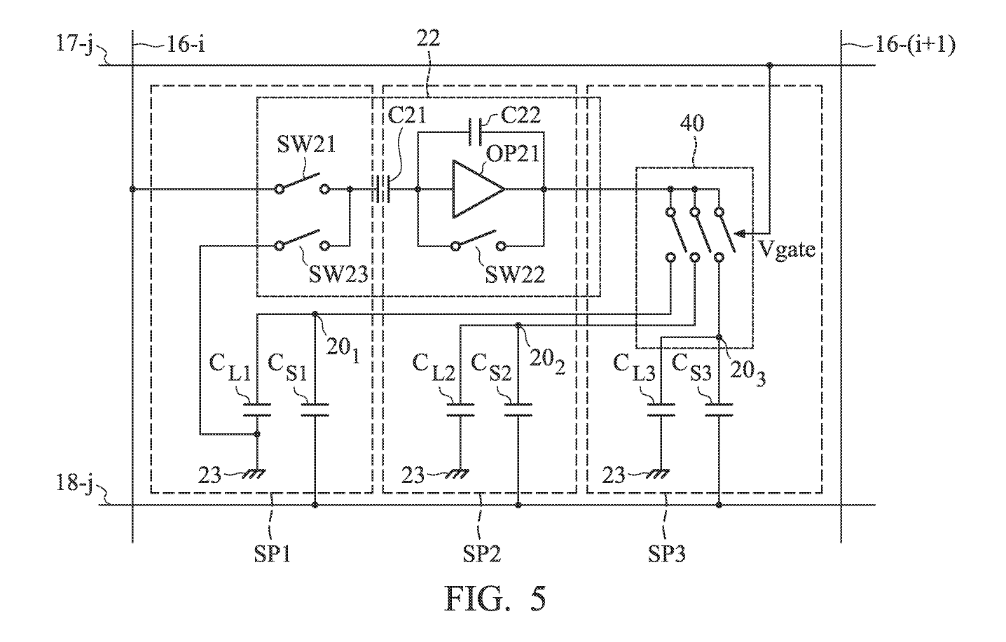

The pixel shown in FIG. 4 further comprises a voltage distribution part 40 shared by all sub pixels SP1, SP2, and SP3. The voltage distribution part 40 is connected to the output terminal of the amplifier circuit 22 to distribute a signal voltage amplified by the amplifier circuit 22 to each pixel electrode. For example, the voltage distribution part 40 can be a demultiplexer. The demultiplexer 40 can switch to ON/OFF in response to the scan signal provided by the gate driver 13 via the gate line 17-j. In this structure, the switch element 21 can be omitted as shown in FIG. 5.

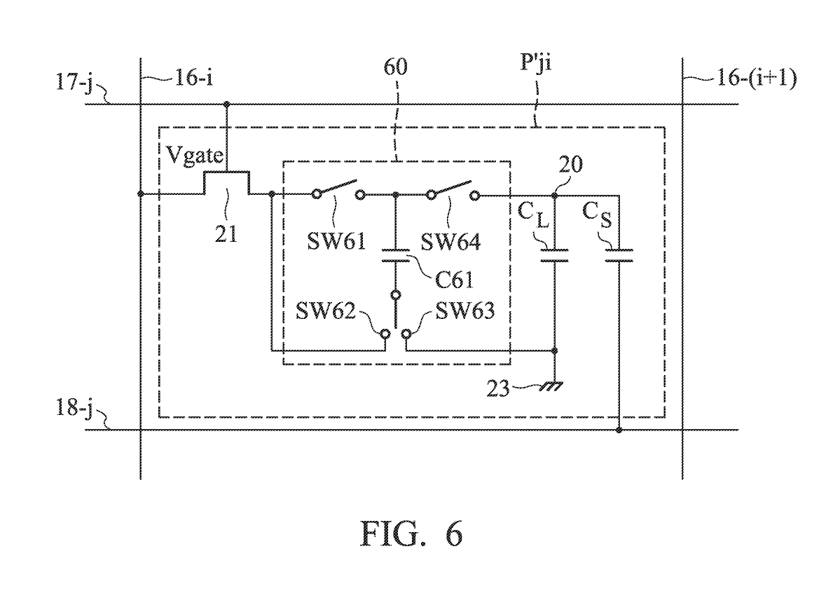

FIG. 6 is another circuitry diagram of a pixel in the display device in accordance with Embodiment 1 of the invention. Except the amplifier circuit 60 is a charge pump circuit rather than a negative feedback amplifier circuit. The pixel Pⱼᵢ′ shown in FIG. 6 has the same structure as that of the pixel Pⱼᵢ shown in FIG. 2.

The amplifier circuit 60 comprises a capacitor C61, and switches SW61, SW62, SW63, and SW64. The first switch SW61 is connected between the switch element 21 and the first terminal of the capacitor C61. The second switch SW62 is connected between the switch element 21 and the second terminal of the capacitor C61. The third switch SW63 is connected between the common electrode 23 and the second terminal of the capacitor C61. The fourth switch SW64 is connected between the pixel electrode 20 and the first terminal of the capacitor C61.

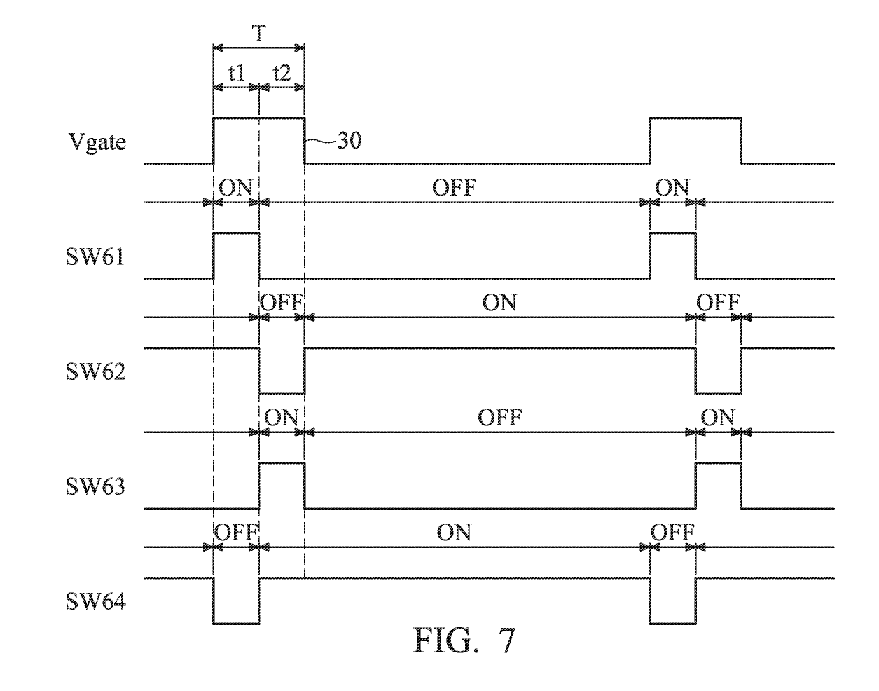

FIG. 7 is a timing chart for describing the operation of the amplifier circuit 60 shown in FIG. 6.

In the example shown in FIG. 7, the gate driver 13 applies a scan signal 30 to the gate line 17-j to drive the pixels Pⱼᵢ˜Pⱼₘ in the j-th row. During the scan period T in which the scan signal 30 is being applied, the switch element 21 is ON.

Before the scan period T, the first switch SW61 and the third switch SW63 is OFF and the second switch SW62 and the fourth switch SW64 is ON.

During a time duration t1, starting at the beginning of the scan period T, the amplifier circuit control part 14 turns on the first switch SW61 and turns off the fourth switch SW64. Meanwhile, the second switch SW62 is still ON and the third switch SW63 is still OFF. The charge pump circuit is separated from the display capacitor C_{L} and the capacity storage capacitor C_{S} and coupled to the source line 16-i. Thereby, a signal voltage applied by the source driver 12 to the source line 16-i is charged into the capacitor C61.

During a time duration t2, starting at the end of time duration t1 and ending at the end of the scan period T, the amplifier circuit control part 14 turns off the first switch SW61 and the second switch SW62, and turns on the third switch SW63 and the fourth switch SW64. The charge pump circuit is separated from the source line 16-i and coupled to the display capacitor C_{L} and the capacity storage capacitor C_{S}. Thereby, the charge pump circuit outputs an amplified signal voltage to the pixel electrode 20 to drive the liquid crystal display element C_{L}.

After the scan period T, the amplifier circuit control part 14 turns on the second switch SW62 and turns off the third switch SW63. Meanwhile, the first switch SW61 is still OFF, and the fourth switch SW64 is still ON. Thereby, the capacity storage capacitor C_{S} holds the amplified signal voltage in the form of electrical charges till the next scan for the pixel Pⱼᵢ′.

As shown in FIGS. 6 and 7, the amplifier circuit arranged in each pixel can be a charge pump circuit rather than a negative feedback amplifier circuit. The amplifier circuit is also not limited to being a charge pump circuit or a negative feedback amplifier circuit. Other amplifier circuits can be arranged in a pixel to amplify a signal voltage. Note that the charge pump circuit and the negative feedback amplifier circuit are not limited to the structures described in Embodiment 1. For example, the negative feedback amplifier circuit can use resistances to replace switches and capacitors thereof.

### Embodiment 2

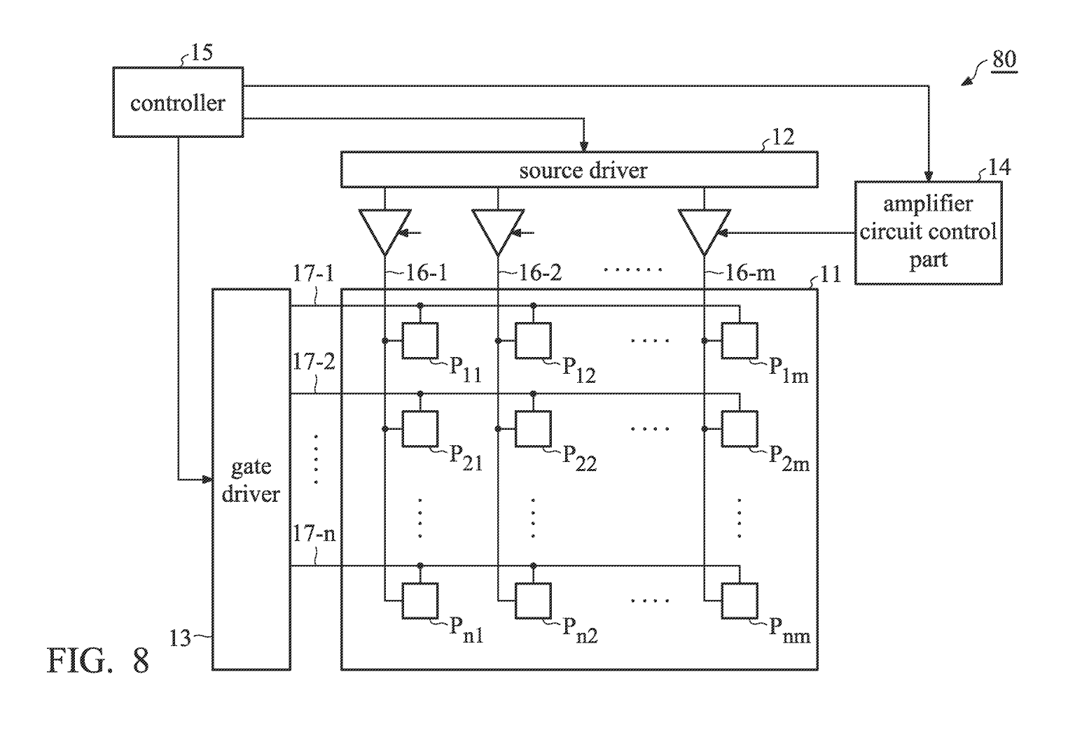

FIG. 8 is a block diagram of a display device in accordance with Embodiment 2 of the invention. In FIG. 8, a display device 80 comprises a display panel 11, a source driver 12, a gate driver 13, an amplifier circuit control part 14, and a controller 15.

In the display device 80 shown in FIG. 8, the amplifier circuit control part 14 controls amplifier circuits arranged on the source lines 16-1˜16-m between the source driver 12 and the pixel columns. Besides this, the display device 80 has the same structure as that of the display device 10 shown in FIG. 1.

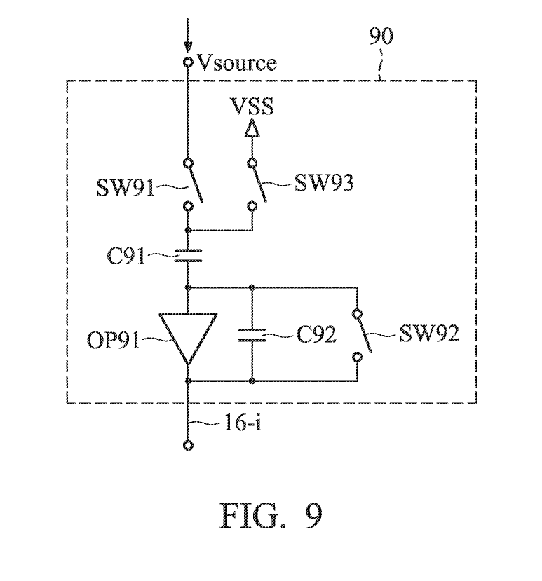

FIG. 9 is a circuitry diagram of an amplifier circuit arranged on each source line in the display device in accordance with Embodiment 2.

An amplifier circuit 90 is arranged on each source line between the source driver 12 and the pixel columns to amplify a signal voltage applied by the source driver 12 to the source line 16-i to a driving voltage capable of driving pixels connected to the source line 16-i. The amplifier circuit 90 is a negative feedback amplifier circuit which uses switches and capacitors. The amplifier circuit 90 comprises an operational amplifier OP91, capacitors C91 and C92, and switches SW91, SW92, and SW93. The first capacitor C91 is connected to the input terminal of the operational amplifier OP91. The second capacitor C92 is connected between the input terminal and the output terminal of the operational amplifier OP91. The first switch SW91 is connected between the input terminal of the amplifier circuit 90 (also the output part of the source driver 12) and the first capacitor C91. The second switch SW92, connected in parallel with the second capacitor C92, is connected between the input terminal and the output terminal of the operational amplifier OP91. The third switch SW93 is connected between a fixed voltage source VSS (for example, grounding) and a node located between the first switch SW91 and the first capacitor C91. The switches SW91˜SW93 are switched ON/OFF in response to control signals applied by the amplifier circuit control part 14, respectively.

In this manner, an amplified signal voltage is applied to each of the pixels P₁ᵢ˜Pₙᵢ connected to the source line 16-i, and the pixels P₁ᵢ˜Pₙᵢ are driven.

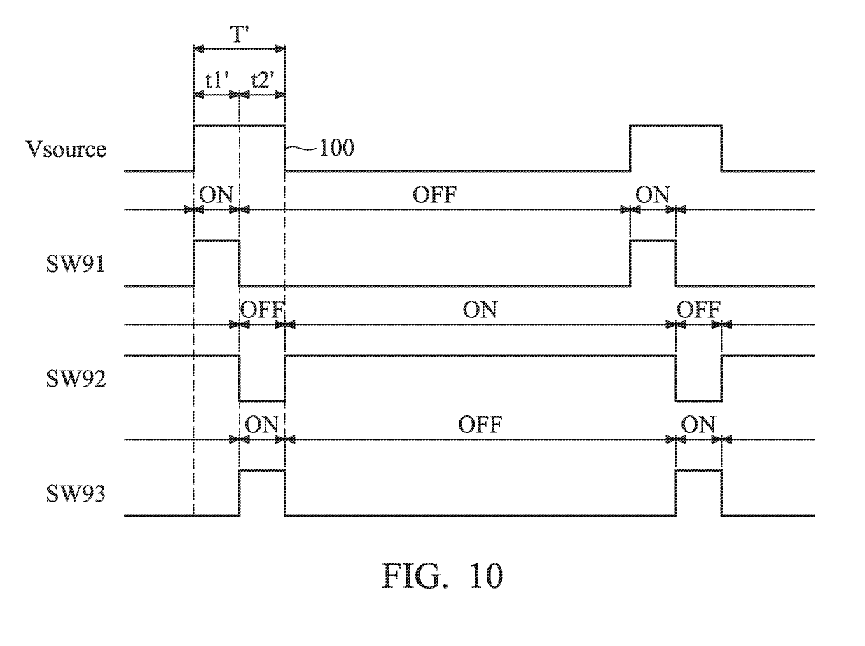

FIG. 10 is a timing chart for describing the operation of the amplifier circuit 90 shown in FIG. 9.

In the example shown in FIG. 10, in response to a clock signal sent from the controller 15, the source driver 12 distributes a signal voltage to each of the source lines 16-1˜16-m in a time-division manner

Before a signal voltage 100 is applied to the source line 16-i, namely, before the scan period T′, the first switch SW91 and the third switch SW93 is OFF and the second switch SW92 is ON.

When the a signal voltage 100 is started being applied to the source line 16-i, namely, during a time duration t1′ starting at the beginning of the scan period T′, the amplifier circuit control part 14 turns on the first switch SW91. Meanwhile, the second switch SW92 is still ON and the third switch SW93 is still OFF. The input terminal of the negative feedback amplifier circuit is coupled to the source driver 12, and thereby a signal voltage applied by the source driver 12 to the source line 16-i is charged into the first capacitor C91.

During a time duration t2′, starting at the end of time duration t1′ and ending at the end of the scan period T′, the amplifier circuit control part 14 turns off the first switch SW91 and the second switch SW92, and turns on the third switch SW93. The negative feedback amplifier circuit is separated from the source driver 12 and provides an amplified signal voltage to the pixels P₁ᵢ˜Pₙᵢ connected to the source line 16-i to drive the pixels P₁ᵢ˜Pₙᵢ.

After the signal voltage 100 is finished being applied to the source line 16-i, namely, after the scan period T′, the amplifier circuit control part 14 turns on the second switch SW92 and turns off the third switch SW93. Meanwhile, the first switch SW91 is still OFF. Hereafter, the amplifier circuit 90 performs the same amplifying operation every time the signal voltage 100 is applied to the source line 16-i.

As shown in FIGS. 9 and 10, by setting the amplifier circuit on each source line, the voltage level of the signal voltage applied by the source driver 12 can be lowered. Thus, the display device in accordance with Embodiment 2 can reduce power consumption thereof.

The amplifier circuit arranged on each source line can adopt a charge pump circuit to replace the negative feedback amplifier circuit. Note that a negative feedback amplifier circuit is not limited to the structures described in Embodiment 2. For example, a negative feedback amplifier circuit can use resistances to replace switches and capacitors thereof.

### Embodiment 3

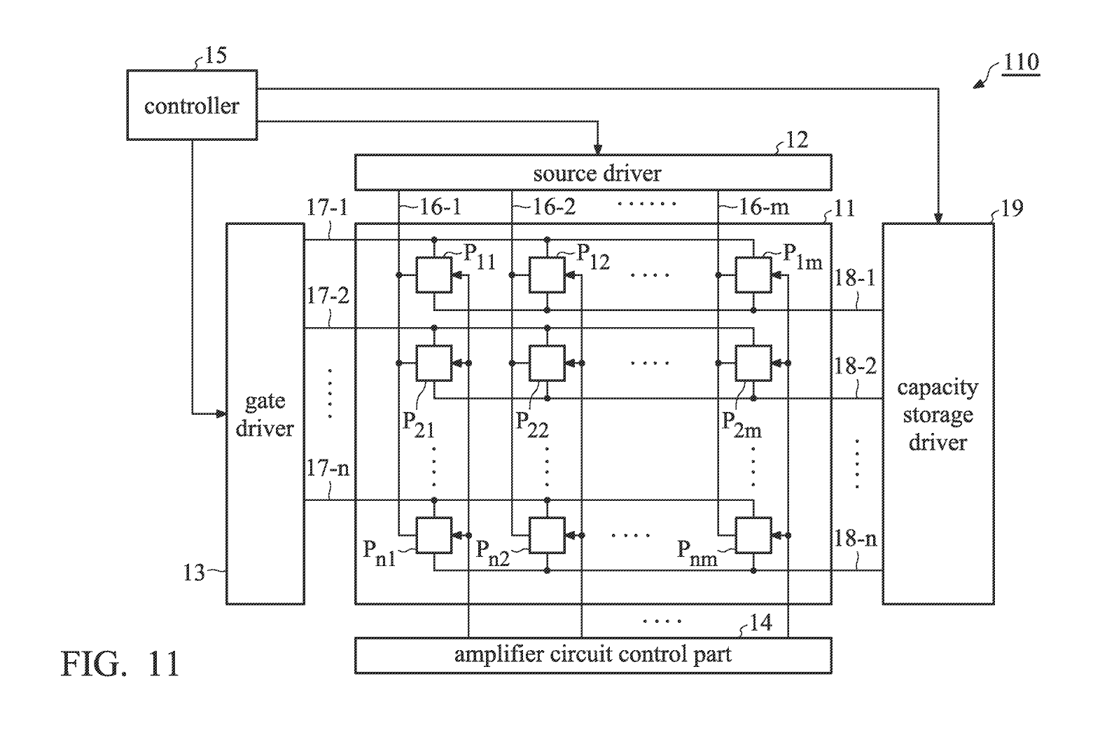

FIG. 11 is a block diagram of a display device in accordance with Embodiment 3 of the invention. In FIG. 11, a display device 110 comprises a display panel 11, a source driver 12, a gate driver 13, an amplifier circuit control part 14, and a controller 15.

The display device 110 shown in FIG. 11 further comprises capacity storage lines 18-1˜18-n arranged corresponding to the pixel rows and parallel to the gate lines 17-1˜17-n, and a capacity storage driver 19 driving the capacity storage lines 18-1˜18-n in synchronization with the driving of the pixels (namely, in synchronization with the operation where the gate driver 13 applies scan signals to the gate lines 17-1˜17-n). Besides this, the display device 110 shown in FIG. 11 has the same structure as that of the display device 10 shown in FIG. 1.

By the control of the controller 15, the capacity storage driver 19 drives the capacity storage lines 18-1˜18-n in synchronization with the gate lines 17-1˜17-n applied with scan signals. Thereby, the voltage level of each capacity storage line is switched at between 2 or above 2 values in synchronization with the driving of the corresponding pixel row. Each of the capacity storage lines 18-1˜18-n is connected to a capacity storage capacitor C_{S} in a pixel. The voltage level of a pixel electrode is shifted in response to the driving of the capacity storage lines 18-1˜18-n because of capacitive coupling.

Shifting a pixel voltage level by driving a capacity storage line as described above is usually called capacitive coupling driving. All embodiments of the invention shown in FIG. 1-10 can adopt capacitive coupling driving.

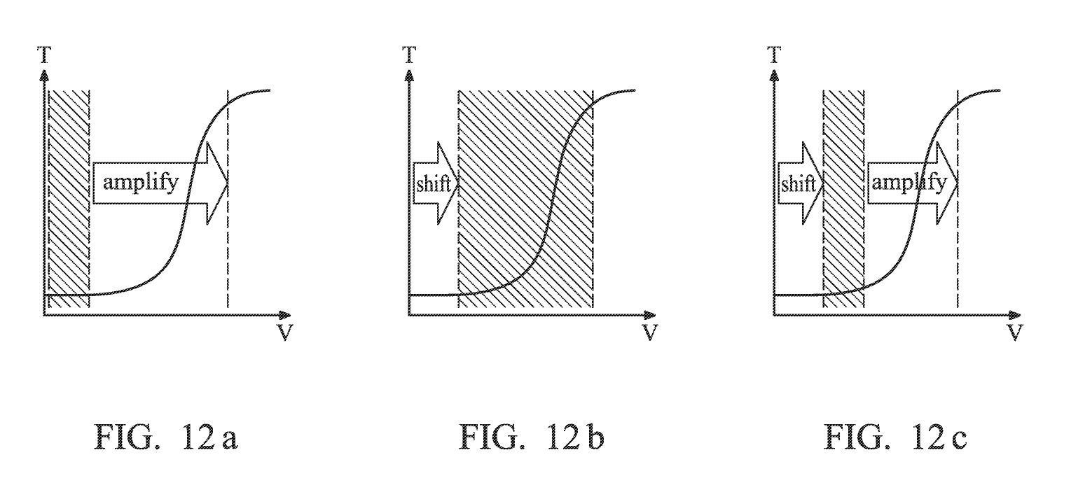

FIG. 12 shows the effect of the capacitive coupling driving adopted in one of structures of the invention.

FIGS. 12a, 12b, and 12c show the relationship between the applied voltage (V) and transmittance (T) in the case where only the structure of the invention is utilized, only capacitive coupling driving is utilized, and both of them are utilized, respectively. In each Fig. the oblique line region represents an output voltage range of the utilized driver IC.

In the conventional display device, a driver IC is capable of outputting voltage that is greater than a threshold value at which a pixel's transmittance starts to change. As shown in FIG. 12a, in the case where the structure of the invention is utilized, because an amplifier circuit for amplifying signal voltages provided by the source driver is used, a driver IC which can only output a voltage lower than the threshold value can be used.

In the case where capacitive coupling driving is utilized, a driver IC identical to the conventional one is used. However, as shown in FIG. 12b, the voltage range of the driver IC, which is located in an under-threshold-value region where the pixel's transmittance does not change, is shifted.

Therefore, in the case where both the structure of the invention and capacitive coupling driving are utilized, as shown in FIG. 12c, the driver IC which can only output voltage lower than the threshold value can be used, and furthermore the voltage range of the driver IC, which is located in an under-threshold-value region where the pixel's transmittance does not change, is shifted. Thus, capacitive coupling driving is suitable for the structure of the invention.

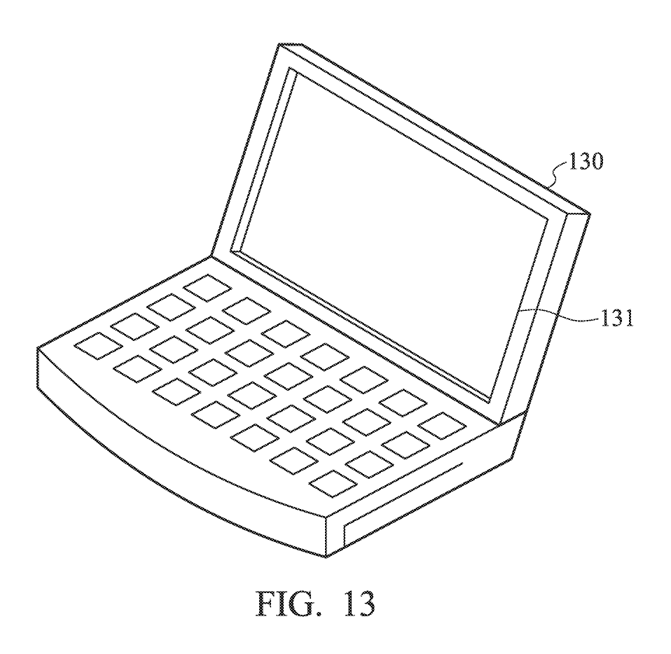

FIG. 13 is an example showing an electronic device in accordance with an embodiment of the invention. The electronic device 130 in FIG. 13 is represented by a laptop personal computer, but other electronic devices such as a television, a cell phone, a watch, a PDA, a desktop computer, a car navigation device, a portable game device, an AURORA VISION, or etc. are also suitable for the invention.

The laptop personal computer 130 is provided with a display device 131, and the display device 131 has a display panel to show information in the form of images. The display device 131 is any one of the display devices referring to FIGS. 1-12, having an amplifier circuit to amply signal voltages output by the source driver. Therefore, the display device 131 can use a driver outputting low voltage to drive display elements of the display device 131 and reduce power consumption of the entire electronic device.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

For example, though the invention mainly takes an LCD (liquid crystal display) device as an example, other display devices, such as OLED (organic light emitting diode) device, electronic paper or etc, are allowed to use the invention. Especially for electronic paper, display elements need higher driving voltage than in an LCD device, so a low-cost driver IC generally used in an LCD device can not be used. However, a low-cost and general-purpose driver IC can be used in electronic paper by utilizing the structure of the invention.

What is claimed is:

1. A display device, comprising:
a plurality of pixels arranged in a matrix formed by rows and columns;
a plurality of signal lines arranged corresponding to each pixel row or each pixel column, respectively;
a signal voltage generating part connected to the plurality of pixels via the plurality of signal lines, for generating a signal voltage to be applied to each of the plurality of signal lines; and
a signal voltage amplifying part for amplifying the signal voltage generated by the signal voltage generating part to a necessary drive voltage for each of the plurality of pixels.

2. The display device as claimed in claim 1, further comprising:
a display panel divided into the plurality of pixels, wherein the display panel has a substrate where a circuit is formed, and the circuit is disposed corresponding to each of the plurality of pixels to control the driving of the pixel,
wherein the signal voltage generating part is comprised in a driver integrated circuit disposed outside of the display panel, and
the signal voltage amplifying part is formed together with the circuit on the substrate.

3. The display device as claimed in claim 1 or claim 2, wherein the signal voltage amplifying part is formed in each of the plurality of pixels.

4. The display device as claimed in claim 3, wherein in the case where each of the plurality of pixels having the signal voltage amplifying part is divided into a plurality of sub pixels, the signal voltage amplifying part comprises a voltage distribution part disposed at an output terminal of the signal voltage amplifying part, wherein the voltage distribution part distributes the signal voltage amplified by the signal voltage amplifying part to the plurality of sub pixels.

5. The display device as claimed in claim 4, wherein the voltage distribution part comprises a demultiplexer.

6. The display device as claimed in claim 5, wherein the signal voltage amplifying part is disposed on each of the plurality of signal lines.

7. The display device as claimed in claim 1 or claim 2, wherein the signal voltage amplifying part is an amplifying circuit having an operational amplifier.

8. The display device as claimed in claim 1 or claim 2, wherein the signal voltage amplifying part is a charge pump circuit.

9. The display device as claimed in claim 1 or claim 2, further comprising:
a capacity storage capacitor formed in each of the plurality of pixels, for holding the drive voltage applied to the pixel;
a plurality of capacity storage lines arranged corresponding to each of the pixel rows or each of the pixel columns and connected to the capacity storage capacitor; and
a capacity storage line driver for driving the plurality of capacity storage lines in synchronization with the driving of each of the plurality of pixels.

10. The display device as claimed in claim 1 or claim 2, wherein the display device is an LCD device, an OLED device, or electronic paper.

11. An electronic device, comprising the display device as claimed in claim 1 or claim 2.
